(19) United States
(12) Patent Application Publication
(10) Pub. No.: US 2023/0249504 A1
(43) Pub. Date: Aug. 10, 2023

(54) Security Lock and Cover for Trailer Jacks

(71) Applicant: Juan Andres Matheus, Rapid City, SD (US)

(72) Inventor: Juan Andres Matheus, Rapid City, SD (US)

(21) Appl. No.: 18/106,969

(22) Filed: Feb. 7, 2023

Related U.S. Application Data
(60) Provisional application No. 63/307,597, filed on Feb. 7, 2022.

(51) Int. Cl. B60D 1/60; B60D 1/66

(52) U.S. Cl. CPC B60D 1/60; B60D 1/66

(57) ABSTRACT

A trailer jack lock for securing both manually operated and electrically operated trailer jacks. The trailer jack lock uses an over-under engagement of the trailer jack lock with the components of a trailer jack to prevent manipulation of hand cranks or electric controls, stopping unauthorized users from using the trailer jack to remove a trailer from a vehicle or mounting it to another vehicle. The trailer jack lock may then prevent the theft or misuse of a trailer while left unattended, such as when a user is traveling or storing the trailer for future use in an unsecure environment. The trailer jack lock may be adapted for any type of trailer jack, and includes a body and locking bar that may be used with widely available locking mechanisms, such as padlocks. The trailer jack lock may also protect a trailer jack from sun, rain, snow, and other elements.

### CROSS REFERENCE TO RELATED APPLICATIONS

The present application claims priority under 35 U.S.C.§ 119(e) from U.S. Provisional Application Ser. No. 63/307,597, filed Feb. 7, 2022, entitled “Lock and Cover for Trailer Jacks,” the disclosure of which is hereby incorporated by reference herein in its entirety.

The present application is related to PCT application with International Application No. PCT/US23/12547, filed Feb. 7, 2023, entitled “Security Lock and Cover for Trailer Jacks,” the disclosure of which is hereby incorporated by reference herein in its entirety.

### FIELD OF THE INVENTION

The present invention relates generally to the field of security equipment. More specifically, the invention is in the subfield of locks for trailer jacks.

### BACKGROUND OF THE INVENTION

Vehicle trailers, whether designed for standard ball hitches, fifth wheel hitches, or the like, generally include a trailer jack at or near the tongue of the trailer for supporting the trailer when it is not connected to a vehicle. The trailer jack may also be used to raise or lower the trailer tongue when attaching the trailer to a vehicle for towing. These trailer jacks, which may take on a number of different configurations and may be manually or power operated, generally do not include any type of security or denial of access measures.

As a result, unauthorized persons may use the trailer jack to mount a trailer to a tow vehicle as a method of theft, to unhitch a trailer that is parked with another vehicle, or to disturb or vandalize an unhitched and unattended trailer. Because of these factors, trailers that utilize a manual or powered jack may lack security and may be easily stolen. As such, there is a need in the art for security mechanisms that may deny unauthorized users the ability to operate or access the trailer jack on commonly available trailers.

### SUMMARY OF THE INVENTION

An aspect of an embodiment of the present invention provides a jack lock and cover that engages with a manual or electronic trailer jack and prevents unauthorized access to the trailer j ack. The jack lock uses an over-under engagement with the trailer jack to prevent access and use of the jacking mechanism while also preventing removal of the trailer jack unless a user has access to the key or combination of an integrated lock or a lock used in conjunction with the jack lock. The jack lock and cover may be configured to engage or secure trailer jacks with top-mount crank handles, side mount crank handles, or electrically operated trailer jacks which have buttons or other switches for the control and operation of the trailer jack. In certain embodiments, the jack lock may engage with the crank or handle of the trailer jack to prevent its rotation or manipulation. In other embodiments, the jack lock may cover the jack lock to prevent access to buttons, levers, or other controls.

The present invention trailer jack lock provides a method for allowing the secure storage or use of a trailer by denying an unauthorized user the ability to manipulate or use the trailer jack. This prevents an unauthorized user from using the trailer jack to remove the trailer from an authorized towing vehicle, or to mount the trailer to an unauthorized tow vehicle and subsequently steal the trailer and any items contained therein. The trailer jack lock may also provide protection to the trailer jack from sun, rain, snow, and other elements that may tend to degrade the trailer jack over time.

### DESCRIPTION OF THE DRAWINGS

The accompanying drawings, which are incorporated into and form a part of the instant specification, illustrate several aspects and embodiments of the present invention and, together with the description herein, serve to explain the principles of the invention. The drawings are provided only for the purpose of illustrating select embodiments of the invention and are not to be construed as limiting the invention.

FIG. 1 provides a schematic depiction of an exemplary embodiment of a jack lock for a hand-crank trailer jack.

FIGS. 2A and 2B provide schematic depictions of an exemplary embodiment of a locking bar.

FIG. 3 provides a schematic depiction of an exemplary embodiment of a hinged jack lock for a hand-crank trailer jack.

FIGS. 4A and 4B provide schematic depictions of an exemplary embodiment of a jack lock for a hand-crank trailer jack.

FIGS. 5A and 5B provide schematic depictions of an exemplary embodiment of a jack lock for a hand-crank trailer jack.

FIG. 6 provides a schematic depiction of an exemplary embodiment of a jack lock for a hand-crank trailer jack.

FIGS. 7 and 8 provide schematic depictions of an exemplary embodiment of a jack lock for an electric trailer jack.

FIG. 9 provides a schematic depiction of an exemplary embodiment of a jack lock for an electric trailer jack.

FIGS. 10A and 10B provide schematic depictions of an exemplary embodiment of a locking bar.

FIG. 11 provides a schematic depiction of an exemplary embodiment of a hinged jack lock for an electric trailer jack.

FIG. 12 provides a schematic depiction of an exemplary embodiment of a jack lock for a hand-crank trailer jack.

### DETAILED DESCRIPTION OF EXEMPLARY EMBODIMENTS OF THE INVENTION

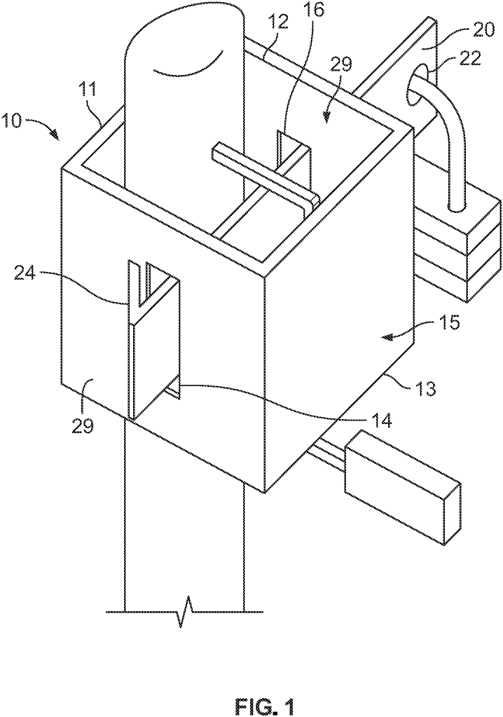

FIG. 1 provides a depictions of a jack lock 10 for engaging a trailer jack with a side-mount crank. The jack lock 10 may comprise a body 12 with a top edge 11, a bottom edge 13, an entry aperture 14 and an exit aperture 16 that works in conjunction with a lock bar 20 that may comprise a lock aperture 22 and a lock bar stop 24. The body 12 of the jack lock 10 may be placed over the trailer jack where it will rest on the lower portion of the trailer jack crank. The end of the lock bar 20 with the lock aperture 22 may then be inserted into the entry aperture 14 and passed through the interior of the jack lock body 12 and subsequently through the exit aperture 16. When the lock bar 20 is fully inserted into the jack lock body 12, the lock bar stop 24, which is too large to pass through the entry aperture 14, will engage with the jack lock body 12 to prevent further movement through the entry aperture 14. It should be appreciated that the entry aperture 14 and exit aperture 16 may define a channel or passage through the body 12 of the jack lock 10 that the lock bar 20 may pass through. In the fully inserted state, the lock aperture 22 of the lock bar 20 may extend through the exit aperture 16 and outside the body 12 of the jack lock 10. A user may then engage a padlock, combination lock, or other locking means with the lock aperture 22 to secure the lock bar 20 and prevent removal of the lock bar 20 from the jack lock body 12.

When properly positioned, the body 12 of the jack lock 10 should be placed over top of the trailer jack such that the bottom edge 13 of the body 12 of the jack lock 10 rests on the lower horizontal portion of the trailer jack crank, or the portion that includes the handle or that is extended farther from the trailer jack post. When the lock bar 20 is inserted into the body 12 of the jack lock 10, the lock bar 20 should be positioned below the upper horizontal portion of the trailer jack crank, or the portion that attaches to the trailer jack post. In this position, the engagement of the jack lock body 12 with the lower horizontal portion of the trailer jack crank prevents downward movement of the jack lock 10. Similarly, the engagement of the lock bar 20 with the upper horizontal portion of the trailer jack crank prevents upward movement of the jack lock 10. By preventing both the upward and downward movement of the jack lock 10, the jack lock 10 is secured to the trailer jack and cannot be removed. When fully engaged with the trailer jack and trailer jack crank, the jack lock 10 prevents a user from turning the trailer jack crank to operate the trailer jack. If a user attempts to turn the trailer jack crank, the front panel 15 of the body 12 of the jack lock 10 may interfere with the lower horizontal portion of the trailer jack crank, or the side panels 29 of the body 12 of the jack lock 10 may interfere with the vertical portion of the trailer jack crank. The side panels 29 of the body 12 of the jack lock 10 may also interfere with the trailer jack post to prevent rotation of the jack lock 10 about the trailer jack.

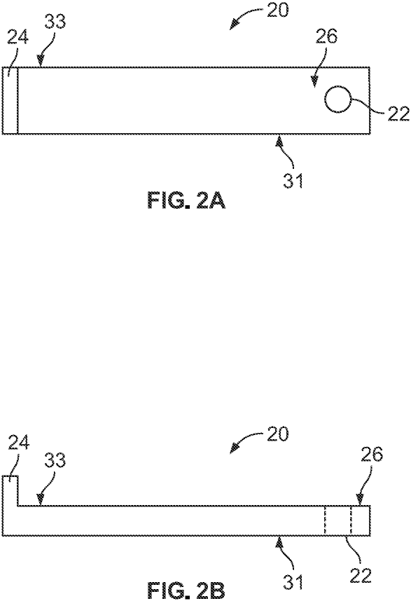

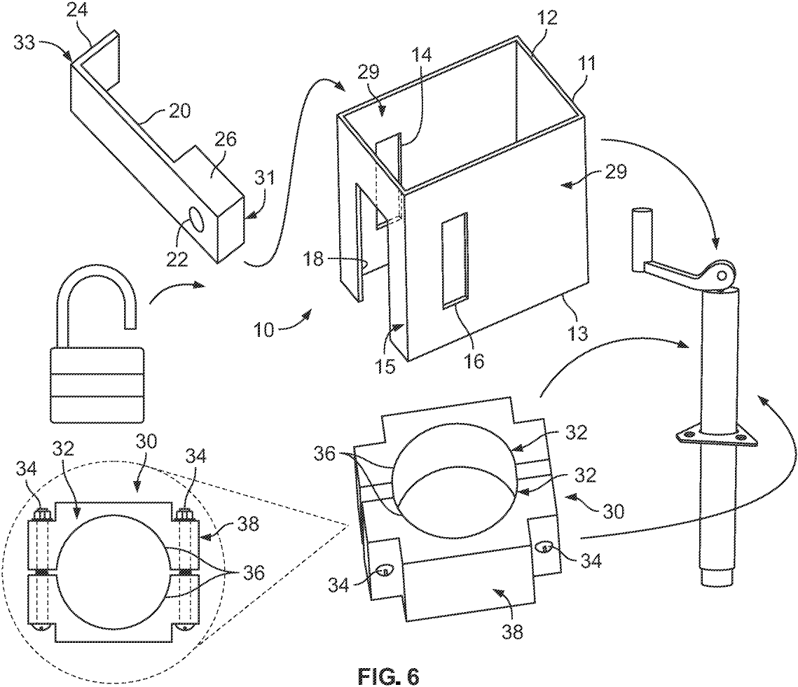

FIGS. 2A and 2B provide depictions of a lock bar 20 with a lock reinforcement 26. The lock bar 20 may include a lock aperture 22 located proximate to a first end 31 and a lock bar stop 24 located proximate to a second end 33 of the lock bar 20. The lock bar reinforcement 26 may be located primarily around or about the lock aperture 22 at the first end 31 of the lock bar 20 (as shown below in FIG. 6), or it may extend along the entire length of the lock bar 20. It should be appreciated that the lock bar 20 may have any cross section including, but not limited to, square, rectangular, circular, oval, elliptical, triangular, or any other regular or irregular shape as desired or required. The lock bar 20 may also be curved or otherwise shaped to provide extra clearance or a more secure engagement with the trailer jack lifting mechanism.

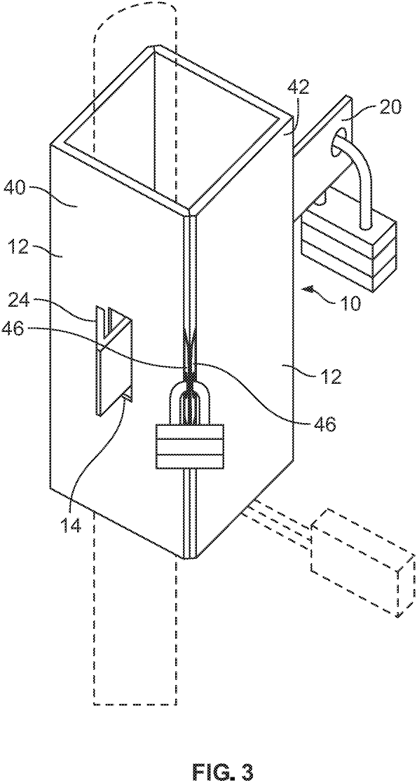

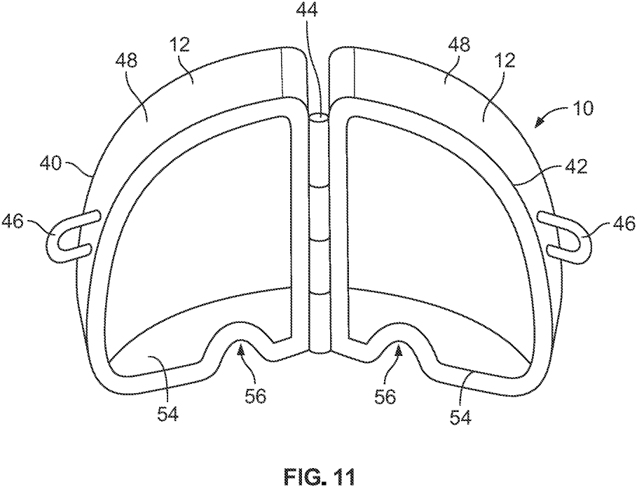

FIG. 3 provides a depictions of a jack lock 10 with a hinged body 12. The jack lock 10 may comprise a body 12 split into a first body section 40 and a second body section 42 connected by a hinge (see hinge 44 in FIG. 11 below). The jack lock 10 may also include an entry aperture 14 in the first body section 40, an exit aperture (not visible) in the second body section 42, and one or more lock rings 46 on each portion of the body 12. The jack lock 10 may also comprise a lock bar 20 with a lock bar stop 24 and a lock aperture (not shown). The first body section 40 and second body section 42 may pivot about the hinge to allow the body 12 of the jack lock 10 to be split or otherwise opened to allow for fitment of the body 12 around a trailer jack without the need to pass the body 12 of the jack lock 10 over the top of the trailer jack. A user may then secure the body 12 of the jack lock 10 about the trailer jack by securing the two lock rings 46 with a padlock, combination lock, or other locking means. The jack lock body 12 is now secured about the trailer jack. The user may then insert the first end of the lock bar 20 with the lock aperture through the entry aperture 14, passing through the interior of the jack lock body 12, and out the exit aperture. The lock bar stop 24 will prevent the second end of the lock bar 20 from passing through the entry aperture 14, and a user may then secure the lock bar 20 with a padlock, combination lock, or other locking means to achieve the over-under engagement of the jack lock 10 with the trailer jack as described above.

Still referring to FIG. 3, the jack lock 10 with a hinged body 12 may also incorporate interlocking edges. The edges of the first body section 40 and second body section 42 that mate together may incorporate one or more features to assist with interlocking the two parts 40, 42 of the body 12 together. For example, one portion of the body 12 may include a recess that is complementary to an extension on the edges of the other portion of the body 12 such that they may fit together to provide a more secure connection when the two portions 40, 42 of the body 12 are mated together. It should be appreciated that the mating edges may include any geometric configuration or number of recesses and extensions as desired or required for a particular application. In certain embodiments, the body 12 of the jack lock 10 may also include top panels to enclose the top of a trailer jack.

It should be appreciated that certain embodiments of the hinged jack lock 10 may not require locking rings 46 to secure the two portions 40, 42 of the jack lock body 12 to a trailer jack. For example, the lock aperture may be located on the lock bar 20 at a distance from the lock bar stop 24 that is close to the linear distance between the entry aperture 14 and the exit aperture. When the user engages a padlock, combination lock, or other locking means with the lock aperture, the distance between the padlock, combination lock, or other locking means and the lock bar stop 24 may confine or otherwise limit the motion of the two portions 40, 42, of the jack lock body 12 to secure them in a closed position. In certain embodiments, the jack lock 10 may also include an integrated locking mechanism that may be used to secure the two portions 40, 42 of the jack lock body 12 together and secure the jack lock 10 to a trailer jack. The integrated locking mechanism may include a combination lock, key-operated lock, or any other locking mechanism as desired or required for a particular application. It should be appreciated that the locking mechanism may be located on the hinge, on or about any mating surface between the two portions 40, 42 of the jack lock body 12, or in any location that may allow for securing the two portions 40, 42 of the jack lock body 12 to one another, the trailer jack, or both.

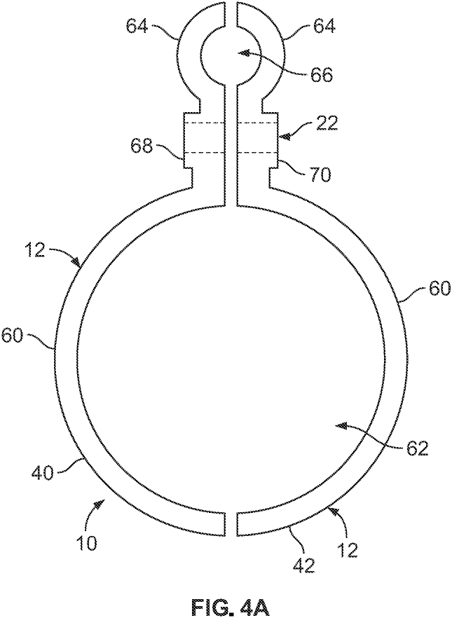

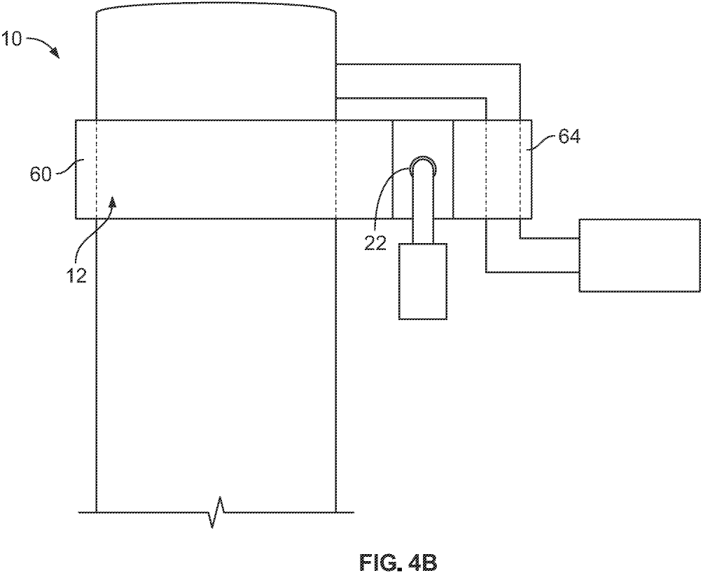

FIGS. 4A and 4B provide depictions of an exemplary embodiment of a jack lock 10 comprising a body 12 split into a first body section 40 and a second body section 42 contoured such that each half or portion 40, 42 of the body 12 comprises a crank grip 64 and a post grip 60 at opposite ends of the body portions 40, 42. The crank grip 64 and post grip 60 of each portion 40, 42 of the body 12 may each be shaped, contoured, or otherwise formed into complementary sections that, when joined together, may define a crank aperture 66 and post aperture 62, respectively. As shown, the crank grip 64 and post grip 60 may each be semicircular on each portion or half 40, 42 of the jack lock body 12 to form approximately circular crank 66 and post 62 apertures. It should be appreciated that the crank grip 64, post grip 60, or both may take on any geometry, including but not limited to, circular, elliptical, oval, rectangular, triangular, or any other shape or geometry as desired or required for a particular application and to ensure proper fit and function with a particular trailer jack. The first body section 40 and second body section 42 may each include a first lock aperture 68 and a second lock aperture 70, respectively, that, when the two halves or portions 40, 42 of the body 12 of the jack lock 10 are brought or joined together, align to form a single lock aperture 22 through which a lock, bar, or other device may pass.

Referring specifically to FIG. 4B, a user may mount the jack lock 10 to a trailer jack with a side-mount crank by placing each portion or half 40, 42 of the jack lock body 12 around the trailer jack such that the post of the trailer jack is located within the post aperture 62 defined by the post grips 60 and the vertical portion of the trailer jack crank is located within the crank aperture 66 defined by the crank grips 64. In this position, the user may then pass the shackle or shank of a padlock or other locking mechanism through the lock aperture 22 to secure the jack lock 10 to the trailer jack.

Still referring to FIG. 4B, the jack lock 10 prevents cranking or operation of the trailer jack by securing the trailer jack crank into a fixed position relative to the trailer jack post. Should a user or other person attempt to rotate the trailer jack crank, interference with the crank grip 64 of the jack lock 10 will prevent turning of the trailer jack crank while interference between the post grip 60 and the trailer jack post prevents turning of the jack lock body 12. As such, the trailer jack crank cannot be rotated relative to the trailer jack post and the trailer jack cannot be operated. The jack lock 10 is also secured from removal by the over-under engagement of the jack lock 10 with the trailer jack. The jack lock 10 may not be moved further down the trailer jack post because the crank grip 64 of the jack lock body 12 interferes with the lower horizontal portion of the trailer jack crank. Similarly, the jack lock 10 may not be removed in an upward direction because the lock passing through the lock aperture 22 of the body 12 of the jack lock 10 between the post grip 60 and crank grip 64 will interfere with the upper horizontal portion of the trailer jack crank. In certain embodiments, the crank grip 64 of the jack lock 10 may also interfere with the upper horizontal portion of the trailer jack crank.

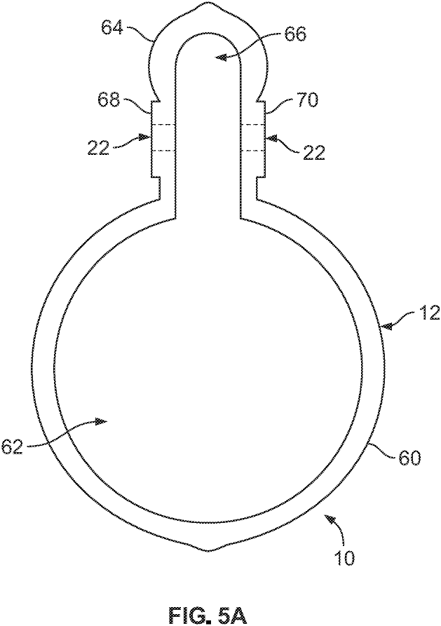

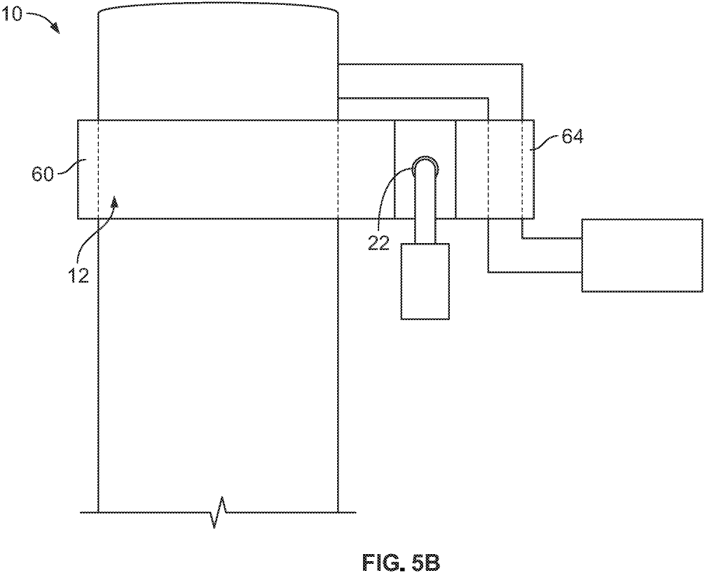

FIGS. 5A and 5B provide depictions of an exemplary embodiment of a jack lock 10 comprising a body 12 with a post grip 60 and a crank grip 64 formed at opposite ends thereof. The jack lock 10 may also comprise a first lock aperture 68 and second lock aperture 70, defining a joint lock aperture 22, disposed between the post grip 60 and the crank grip 64. The body 12 of the jack lock 10 may partially enclose a space, comprising a crank aperture 66 defined by the crank grip 64 and a post aperture 62 defined by the post grip 60. As shown, the crank grip 64 and post grip 60 may be approximately circular in cross section, but it should be appreciated that the crank grip 64, post grip 60, or both may take on any shape as desired or required for a particular application. For example, the crank grip 64, post grip 60, or both may be circular, oval, elliptical, rectangular, triangular, or any other shape necessary to ensure proper fit and function with a particular trailer jack.

Referring to FIG. 5B, a user may mount the jack lock 10 to a trailer jack with a side-mount crank by aligning the crank aperture 66 with the vertical portion of the trailer jack crank and aligning the post aperture 62 with the trailer jack post. The user may then slide the jack lock 10 over the trailer jack and engage the post aperture 62 with the trailer jack post and the crank aperture 66 with the trailer jack crank. The shank or shackle of a padlock or other locking mechanism may then be passed through the first lock aperture 68 and second lock aperture 70 to secure the jack lock 10 to the trailer jack.

Still referring to FIG. 5B, the jack lock 10 prevents cranking or operation of the trailer jack by securing the trailer jack crank into a fixed position relative to the trailer jack post. Should a user or other person attempt to rotate the trailer jack crank, interference with the crank grip 64 of the jack lock 10 will prevent turning of the trailer jack crank while interference between the post grip 60 and the trailer jack post prevents turning of the jack lock body 12. As such, the trailer jack crank cannot be rotated relative to the trailer jack post and the trailer jack cannot be operated. The jack lock 10 is also secured from removal by the over-under engagement of the jack lock 10 and padlock or other locking mechanism with the trailer jack. The jack lock 10 may not be moved further down the trailer jack post because the crank grip 64 of the jack lock body 12 interferes with the lower horizontal portion of the trailer jack crank. Similarly, the jack lock 10 may not be removed in an upward direction because the shank or shackle of the padlock or other locking mechanism will interfere with the upper horizontal portion of the trailer jack crank.

FIG. 6 provides a depiction of a jack lock 10 adapted for use with a trailer jack with a top-mounted crank. The jack lock 10 may comprise a body 12 with an entry aperture 14 and an exit aperture 16 in located in side panels 29, and a clearance aperture 18, in front panel 15. The body 12 may also comprise a top edge 11 and a bottom edge 13. The clearance aperture 18 may extend into and through the bottom edge 13 of the body 12. The jack lock 10 may also include a lock bar 20 with a lock aperture 22 located about a first end 31 and a lock bar stop 24 located about a second end 33. The jack lock body 12 may be placed over the trailer jack such that the clearance aperture 18 is aligned with and receives the extended trailer jack crank. The body 12 of the jack lock 10 will then rest on the trailer jack crank. The lock bar 20 may then be inserted into the entry aperture 14, through the body 12 of the jack lock 10, and out through the exit aperture 16 such that the lock aperture 22 extends through the exit aperture 16 outside of the lock body 12 and the lock bar stop 24 engages the lock body 12 to prevent the lock bar stop 24 from passing through the entry aperture 14.

When properly applied, the jack lock 10 will have an over-under engagement with the trailer jack handle and post. For example, when applied, the body 12 of the jack lock 10 will engage with the upper portion of the trailer jack crank handle while the lock bar 20 passes under the trailer jack crank handle to engage the underside of the crank handle. This over-under engagement of the jack lock 10 between the clearance aperture 18 and lock bar 20 prevents vertical movement and removal of the jack lock 10. It should be appreciated that the clearance aperture 18 may be positioned anywhere as desired or required for a particular configuration or arrangement of trailer jack. For example, the clearance aperture 18 may be located roughly in the center of a front panel 15 of the jack lock body 12. However, the clearance aperture 18 may also be offset or otherwise arranged, including being located in other panels or portions of the jack lock body 12, to receive a trailer jack crank that is offset or otherwise positioned away from the central axis of the trailer jack post. In certain embodiments, the body 12 of the jack lock 10 may include multiple clearance apertures 18, either on a single face or arranged on difference faces of the jack lock body, to engage with trailer jack cranks of different configurations.

Still referring to FIG. 6, the jack lock 10 may prevent rotation of the trailer jack crank by engagement of the jack lock body 12 with the trailer jack post and engagement of the trailer jack crank with the clearance aperture 18. For example, when installed in a similar manner as shown in FIG. 1, the trailer jack may have a jack post that is square or otherwise polygonal in shape. In such an arrangement, if a user attempts to turn the trailer jack crank, the body 12 of the jack lock 10 will engage the corners and sides of the trailer jack post and prevent rotation of the trailer jack crank.

In certain embodiments, the jack lock 10 may include a collar 30 or other device for use on trailer jacks with a round post or a post that cannot interfere with the rotation of the jack lock body 12. The collar 30, may comprise two similar or dissimilar pieces, each with a post recess 32, secured by fasteners 34 such as screws, bolts, or any other suitable fastener. In certain embodiments, the collar 30 may be a single piece and adapted to slide over the trailer jack crank and down the trailer jack post. It should be appreciated that the post recess or recesses 32 may be shaped or sized as desired or required for any particular trailer jack post shape or size. The post recess or recesses 32 may also include one or more features to increase the friction or grip of the collar 30 on the trailer jack post. For example, the post recess or recesses 32 may include materials to enhance friction such as rubber, elastomers, polymers, or other coatings that have a higher coefficient of friction. Similarly, the post recess or recesses 32 may incorporate a grip surface 36 of texture, teeth, or other geometric features to enhance the gripping action of the collar 30 about the trailer jack post. The collar 30, as shown, may have an outer perimeter 38 that is square or rectangular in shape, but may also take on any shape or size as desired or required to engage with the any shape of jack lock body 12 as described below.

Still referring to FIG. 6, the lock bar 20 of the jack lock 10 may include a lock aperture reinforcement 26 around or about the lock aperture 22. The lock aperture reinforcement 26 may comprise thicker material or an extra layer of material bonded, brazed, welded, or otherwise affixed to the lock bar 20. The lock aperture reinforcement 26 may function to increase the difficulty of cutting the lock bar 20 or lock aperture 22 by making the material thicker and so that the material may not easily fit within the jaws of bolt cutters or other cutting implements. It should be appreciated that the entry aperture 14 and exit aperture 16 of the jack lock body 12 must be sized to allow for clearance of the lock aperture reinforcement 26 to pass through both the entry aperture 14 and exit aperture 16. The lock bar stop 24 should then be sized such that it is larger than the entry aperture 14, and consequently larger than the lock aperture reinforcement 26, to prevent the lock bar 20 from passing completely through the entry aperture 14 of the jack lock body 12. The lock aperture reinforcement 26 may also be applied to any other embodiment of the jack lock 10 as described herein which uses a lock bar 20.

Referring to FIGS. 1-3 and 6, the jack lock 10 and its associated components may take on any number of shapes, sizes, or configurations as desired or required for a particular application. For example, the body 12 of the jack lock 10 may be sized with larger or smaller internal dimensions to accommodate different sizes and configurations of trailer jack and trailer jack crank. The body 12 of the jack lock 10 should be configured such that there is sufficient clearance to encompass the trailer jack and crank, but without so much clearance as to allow free rotation or removal of the jack lock 10 when the lock bar 20 is engaged. The body 12 of the jack lock 10 may also take on a variety of shapes including, but not limited to square, rectangular, circular, oval, elliptical, triangular, or any other regular or irregular geometric shape. Furthermore, the body 12 of the jack lock 10, regardless of its shape, may be tapered such that it is wider at one end compared to the other, or bowed inward or outward.

Still referring to FIGS. 1-3 and 6, the body 12 of the jack lock 10 may include other modifications or alterations for adapting its use to a particular application. In certain embodiments, the location of the entry aperture 14 and exit aperture 16 may be adjusted to allow for fitment of the body 12 and lock bar 20 of the jack lock 10 to different trailer jacks. For example, the entry aperture 14 and exit aperture 16 may be located higher or lower on the body 12, or closer or farther from the front panel 15 of the jack lock body 12 to accommodate trailer jacks with different configurations or geometries of crank mechanism. It should be appreciated that the body 12 of the jack lock 10 may also incorporate multiple entry apertures 14 and multiple exit apertures 16 to allow one jack lock body 12 to be applied to multiple trailer jacks. The multiple entry apertures 14 and multiple exit apertures 16 may be located on one pair of opposing sides of the jack lock body 12, or every side of the jack lock body 12 may include entry apertures 14 and exit apertures 16 for different configurations of trailer jack. In certain embodiments, the jack lock 10 may include a lock bar 20 that is curved or otherwise non-linear to engage with a wider variety of trailer jacks. It should be appreciated that the jack lock 10 may also be provided as a kit with multiple bodies 12, lock bars 20, or both, to fit the widest variety of trailer jack configurations.

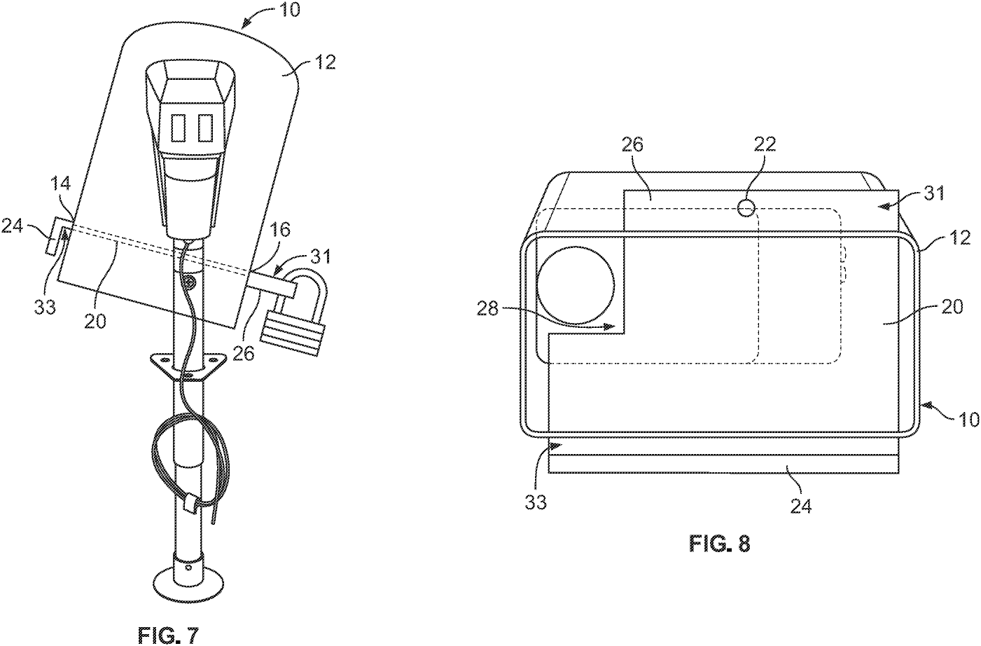

FIGS. 7-10 provide depictions of a jack lock 10 for completely enclosing a trailer jack. In certain cases, it may be desirable to completely enclose the upper portion of a trailer jack, such as when the trailer jack is an electrically operated jack with buttons, levers, or other controls that should be enclosed to prevent unauthorized use. The jack lock 10 may comprise a body 12 with an entry aperture 14 and an exit aperture 16 and a lock bar 20 with a lock aperture 22 located proximate a first end 31 and a lock bar stop 24 located proximate a second end 33. The jack lock body 12 may be partially or fully enclosed at the top portion to provide the upper engagement point and to enclose the trailer jack mechanism to prevent unauthorized uses. To engage the jack lock 10, a user may place the jack lock body 12 over the top of the trailer jack and then insert the first end 31 of the lock bar 20 with the lock aperture 22 through the entry aperture 14, through the interior of the jack lock body 12, and out through the exit aperture 16 of the body 12. The lock bar stop 24 may then prevent further insertion of the lock bar 20 by interfering with the body 12 of the jack lock 10 and preventing the lock bar 20 from passing totally through the entry aperture 14. A user may then secure the lock bar 20 in place by engaging a padlock, combination lock, or other locking means with the lock aperture 22 of the lock bar 20. The lock bar 20 may then provide a lower engagement point underneath the trailer jack lifting mechanism to complete the over-under engagement of the jack lock 10.

In certain embodiments, the jack lock 10 may comprise a body 12 adapted to cover or otherwise enclose the trailer jack. The jack lock body 12 may not have any extra openings, orifices, or apertures to receive a lock bar 20. In such a configuration, the jack lock body 12 serves as a cover to protect the trailer jack from sun, rain, snow, or other elements. It should be appreciated that other embodiments of the jack lock 10 as described herein may also be used as a cover to protect a trailer jack from sun, rain, snow, or other elements with or without the use or engagement of their locking features.

Still referring to FIGS. 7-10, the jack lock body 12, entry aperture 14, exit aperture 16, and lock bar 20 may take on any shape, size, or geometry as desired or required for a particular application. In particular, the jack lock body 12 may have any cross section including, but not limited to, square, rectangular, circular, oval, elliptical, triangular, or any other regular or irregular shape. Furthermore, the body 12 of the jack lock 10, regardless of its shape, may be tapered such that it is wider at one end compared to the other. Similarly, the lock bar 20 may have any type or geometry of lock bar stop 24, and the lock bar 20, entry aperture 14, or exit aperture 16 may have any cross section including, but not limited to, square, rectangular, circular, oval, elliptical, triangular, or any other regular or irregular shape as desired or required. The lock bar 20 may also be curved or otherwise shaped to provide extra clearance or a more secure engagement with the trailer jack lifting mechanism.

Referring to FIGS. 7 and 8, the lock bar 20 of the jack lock 10 may be configured or otherwise provided to serve as a closeout panel for the lower portion of the body 12 of the jack lock 10. As shown, the lock bar 20 may be wider or otherwise increased in size such that it encloses the lower portion of the jack lock body 12, and subsequently the trailer jack. To facilitate full enclosure of the trailer jack, the lock bar 20 may further comprise a pole relief 28 to allow the pole of the trailer jack to extend outside the jack lock body 12. This pole relief 28 may be positioned or otherwise configured such that the trailer jack pole is confined to a single corner of the jack lock body 12, preventing tampering from outside the jack lock 10. However, it should be appreciated that the pole relief 28 may be positioned in any location along the lock bar 20 to allow for a variety of trailer jack pole placements. The entry aperture 14 and exit aperture 16 of the jack lock body 12 may then be sized appropriately to accommodate the increased size of the lock bar 20. In certain embodiments, the entry aperture 14 may be larger than the exit aperture 16 such that the entry aperture 14 may accommodate the whole width of the lock bar 20 but the exit aperture 16 may only accommodate the width of the portion of the lock bar 20 that extends beyond the pole relief 28. As shown, the lock bar 20 may also comprise a lock aperture reinforcement 26 and a lock bar stop 24 which is turned down to help deflect rain, snow, or other precipitation or splashing from being directed inside the jack lock body 12.

The closeout lock bar 20 may comprise a number of modifications or alterations to enhance functionality or security for a particular application. The lock bar 20 may comprise a lock bar stop 24 and a lock aperture 22 at opposing ends of the lock bar 20, and a pole relief 28. The lock bar 20 may also comprise a lock aperture reinforcement 26 to increase the difficulty of cutting or otherwise tampering with the lock aperture 22. The lock bar 20 may also include one or more security tabs. In certain embodiments, the security tab may only extend over a portion of the lock bar 20 that passes through the exit aperture 16 of the jack lock body 12. However, the security tab may also comprise the full width of the lock bar 20 that passes through the exit aperture 16 of the jack lock body 12. In certain embodiments, the lock bar 20 may include both a lock aperture reinforcement 26 and a security tab. It should be appreciated that security tabs may not be required where the distance from the lock aperture 22 to the edge of the lock bar 20 is sufficiently large that tampering or cutting would be difficult with bolt cutters or other cutting implements.

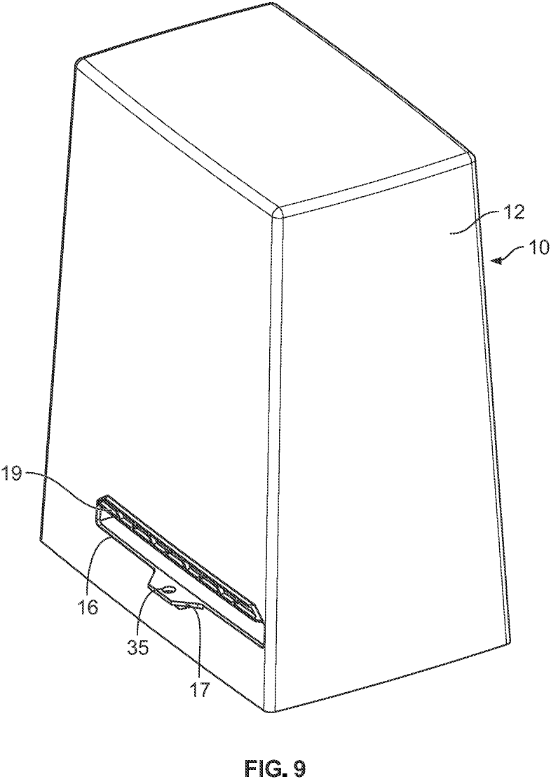

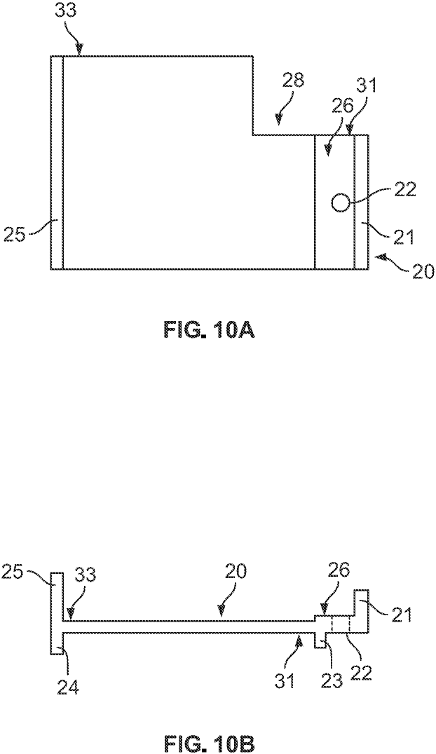

Referring to FIGS. 9 and 10, the jack lock body 12 and lock bar 20 may incorporate additional security features to prevent tampering or other malfeasance from an unauthorized user of the trailer jack, or to ease in the manufacturing and distribution of the jack lock 10. For example, the jack lock body 12 may include a locking tab 17 at or about the exit aperture 16. This locking tab 17 includes an additional lock aperture 35 such that when the lock bar 20 is inserted into the jack lock body 12 and through the exit aperture 16, the lock aperture 22 of the lock bar 20 will align with the lock aperture 35 of the locking tab 17. A user may then pass the shank of a padlock or other locking implement through both the lock aperture 22 of the lock bar 20 and the additional lock aperture 35 of the locking tab 17. This may then attach the lock bar 20 more securely to the jack lock body 12 and prevents an unauthorized user from bending, deflecting, or manipulating the jack lock body 12 to increase the size of the exit aperture 16 and potentially manipulate the controls of an electrically powered trailer jack. The body 12 of the jack lock 10 may also include one or more stacking flanges 19 in the outer or inner surface of the jack lock body 12. These stacking flanges 19 allow for the stacking and nesting of multiple jack lock bodies 12 during manufacturing, shipping, or distribution while reducing the risk that the stacked or nested jack lock bodies 12 become affixed or otherwise stuck to one another through vacuum or other forces.

Referring to FIGS. 10A and 10B, the lock bar may also incorporate a number of additional features to increase the security of the jack lock 10. For example, the lock bar 20 may incorporate a lower lock aperture guard 21 and an upper lock aperture guard 23 around or about the lock aperture 22. These guards 21, 23 provide extra security to the lock aperture 22 by increasing the difficulty of cutting or otherwise damaging the lock aperture 22 and removing the lock bar 20. The upper lock aperture guard 21 and lower lock aperture guard 23 also more fully enclose the exit aperture 16 and prevent insertion of fingers or other tools into the jack lock body 12 to prevent unauthorized use or manipulation of buttons, switches, or other control mechanisms on an electric trailer jack. Similarly, the lock bar 20 may include an upper lock bar stop 24 in conjunction with the existing lock bar stop 25 to prevent insertion of fingers or other tools into the entry aperture 14 of the jack lock body 12. It should be appreciated that similar features for the lock bar 20 may be incorporated into any embodiment of the trailer jack lock 10 described herein.

In certain embodiments, the jack lock body 12 may include integrated cord holder. The jack lock body 12 may comprise an entry aperture 14 and an exit aperture 16 to receive a lock bar 20, and a cord retainer. The cord retainer may be a hook, claw, tab, recess, or other geometrical feature designed to capture and secure an electrical cord, cable, rope, or other similar objects that may be associated with the trailer. In certain embodiments, the cord retainer may include a spring-loaded jaw or clamp designed to capture the cord, cable, or rope and prevent unintentional release.

The jack lock body 12 may also incorporate a flange about its lower edge. The jack lock body 12 may comprise a lower flange around the lower opening of the jack lock 10 to provide extra strength or reinforcement to the jack lock body 12. In certain embodiments, the flange of the jack lock body 12 may be configured to provide extra surface area for the jack lock body 12 to engage with the trailer jack and prevent removal. It should be appreciated that the flange of the jack lock body 12 may be asymmetrical or otherwise configured to be wider or thinner at any point around the jack lock body 12, and may have additional shapes, features, extensions, or protrusions to better engage a trailer jack.

Referring to FIGS. 1-3 and 6-10, the lock bar 20 of the jack lock 10 may include a lock aperture reinforcement 26 around or about the lock aperture 22. The lock aperture reinforcement 26 may comprise thicker material or an extra layer of material bonded, brazed, welded, or otherwise affixed to the lock bar 20. The lock aperture reinforcement 26 may function to increase the difficulty of cutting the lock bar 20 or lock aperture 22 by making the material thicker and so that the material may not easily fit within the jaws of bolt cutters or other cutting implements. It should be appreciated that the entry aperture 14 and exit aperture 16 of the jack lock body 12 must be sized to allow for clearance of the lock aperture reinforcement 26 to pass through both the entry aperture 14 and exit aperture 16. The lock bar stop 24 should then be sized such that it is larger than the entry aperture 14, and consequently larger than the lock aperture reinforcement 26, to prevent the lock bar 20 from passing completely through the entry aperture 14 of the jack lock body 12.

It should be appreciated that a variety of lock bar 20 configurations may be used in conjunction with the jack lock 20. Each lock bar 20 may comprise a lock aperture 22 for receiving a padlock or other user supplied lock and a lock bar stop 24 that may prevent the second end 33 of the lock bar 20 with the lock bar stop 24 from passing through the entry aperture 14 of the body 12 of the jack lock 20. For example, the lock bar stop 24 may include a portion of the lock bar 20 that is folded over, curved, squared off, angled, or otherwise configured to provide a thicker portion of the lock bar 20 that may not pass through the entry aperture 14. Similarly, the lock bar 20 may be bent as with a hitch pin, have an L-shape, a T-shape, oval-shape or a nail head shape to provide a lock bar stop 24. In certain embodiments, the lock bar 20 may be a straight bar with a second lock aperture 22 proximate to its second end 33 for receiving a second padlock in place of a lock bar stop 24.

The lock bar 24 may also include a number of other features to enhance the functionality or security of the lock bar 20 and overall jack lock 10. For example, the lock bar stop 24 may be bent downward (as shown in FIG. 7), upward, both downward and upward, or in any direction relative to the lock bar 20, lock aperture 22, or jack lock body 12. The lock bar 20 may also feature varying thicknesses along its length to provide enhanced security to prevent tampering with the jack lock 10 or trailer jack. For example, the lock bar stop 24 may be made from a thicker material than the lock bar 20 to increase the difficulty of bending or breaking the lock bar stop 24. Similarly, the lock bar 20 may feature a lock aperture reinforcement 26 as shown in FIGS. 2, 6, 7, and 10 to increase the difficulty of cutting into the lock bar aperture 22 by providing more material for added strength and so that the material may not easily fit within the jaws of bolt cutters or other cutting implements. The lock aperture reinforcement 26 may be material of a thicker section, or it may be material that is bonded, welded, brazed, or otherwise affixed around or about the lock aperture of the lock bar. The lock bar may also include one or more security tabs around or about the lock aperture 22 to increase the difficulty of cutting into the lock aperture 22. The one or more security tabs may increase the difficulty of using bolt cutters or other cutting implements by preventing application of the cutting jaws of a bolt cutter or other cutting implement directly about the lock aperture 22. These security tabs may be additional material about the first end 31 and lock aperture 22 of the lock bar 20 that is bent up to deny access to the lock aperture 22. The lock bar 20 may feature one, two, three, or more security tabs to prevent cutting from different directions about the lock aperture 22. In certain embodiments, the one or more security tabs may be bent, formed, or molded from the same material as the lock bar 20. However, it should be appreciated that the one or more security tabs may be bonded, welded, brazed, or otherwise attached to the lock bar 20. Furthermore, the one or more security tabs may take on any shape or geometry as desired or required. The one or more security tabs may be rectangular in shape. However, the one or more security tabs may also be circular, elliptical, oval, or any other shape as necessary. In still further embodiments, the one or more security tabs may be a single curved security tab that surrounds one hundred eighty, two hundred seventy, or three hundred sixty degrees of the perimeter of the lock aperture 22.

The lock bar 20 may also take on a number of configurations as desired or required for a particular application. For example, the lock bar 20 may have a rectangular cross section. However, it may also have a circular, oval, elliptical, triangular, or any other regular or irregular cross section. The cross section of the lock bar 20 may be adapted to complement different shapes of the entry aperture 14 and exit aperture 16 of the jack lock body 12. It should be appreciated that the lock bar 20 as shown is adapted for use with a user-supplied lock such as a padlock or combination lock. However, in certain embodiments, the lock bar 20 may incorporate its own lock and locking mechanism such that a user may disengage a locking cap or similar device, pass the lock bar 20 through the entry aperture 14 and exit aperture 16 of the jack lock body 12, and then secure a locking cap or similar device to the lock bar 20 that may interfere with the exit aperture 16 and prevent removal of the lock bar 20 from the jack lock body 12.

FIG. 11 provides a depiction of a hinged jack lock 10 which encloses the upper portion of a trailer jack. The jack lock 10 may comprise a body 12 split into a first body section 40 and a second body section 42 rotatably affixed by a hinge 44. Each portion 40, 42 of the body 12 of the jack lock 10 may include a lock ring 46 and a top panel 48. A user may engage the jack lock 10 with a trailer jack by opening the body 12 of the jack lock 10, placing it around the trailer jack, and then closing the body 12 and securing it with a padlock, combination lock, or other locking means through the lock rings 46. As shown in FIG. 11, the jack lock 10 may then completely enclose the trailer jack with the top panel 48 of the body 12 and a floor 54 of the body 12 providing the over-under engagement that prevents removal of the jack lock 10 and unauthorized use of the trailer jack mechanism contained within. It should be appreciated that the floor 54 of the body 12 of the jack lock 10 may include one or more post recesses 56 to allow the jack lock 10 to close around the trailer jack post. In certain embodiments, the post recesses 56 may be shaped, sized, or otherwise configured to prevent rotation of the jack lock 10 about the trailer jack post. However, it should be appreciated that the jack lock 10 may also include other lower engagement mechanisms, such as bars, hooks, or other mechanical features in place of the floor 54, that may close around the trailer jack and engage the trailer jack. These engagement bars or mechanisms may then provide the lower engagement of the jack lock 10 while the top panel 48 provides the upper engagement. The engagement bars or mechanisms may be configured in any geometry as necessary to fit a particular trailer jack configuration.

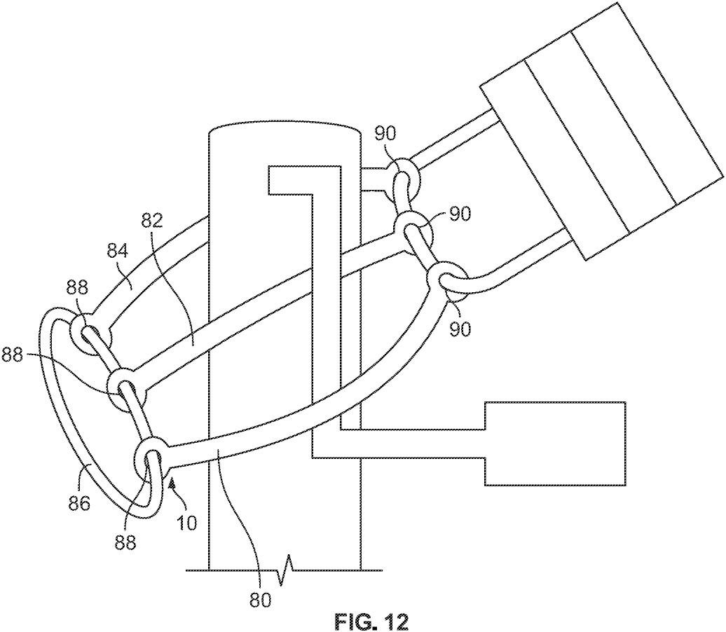

FIG. 12 provides a depiction of an embodiment of a jack lock 10 comprising a series of bars intended to capture the trailer jack crank and operating mechanism. The jack lock 10 may comprise a front bar 80, an intermediate bar 82, and a rear bar 84, each having a ring aperture 88 and a lock aperture 90. The front bar 80, intermediate bar 82, and rear bar 84 may be attached or otherwise affixed to a ring 86 passing through the respective ring apertures 88 of the three bars 80, 82, 84. Similarly, the lock apertures 90 of the three bars 80, 82, 84 may be captured by a padlock, combination lock, or other locking means. To apply the jack lock 10, a user may arrange the rear bar 84 behind the trailer jack post, the intermediate bar 82 under the upper horizontal portion of the trailer jack crank, and the front bar 80 over the lower horizontal portion of the trailer jack crank. The engagement of the intermediate bar 82 with the upper horizontal portion of the trailer jack crank and the front bar 80 with the lower horizontal portion of the trailer jack crank provides the under-over engagement of the jack lock 10 with the trailer jack and the lifting mechanism. The upper engagement of the intermediate bar 82 prevents upward movement of the jack lock 10 while the lower engagement of the front bar 80 prevents downward motion of the jack lock 10. The jack lock 10 is also restricted in motion by the engagement of the front 80, intermediate 82, and rear bars 84 by their engagement with the trailer jack post and the vertical portion of the trailer jack crank. When applied to the trailer jack, the three bars 80, 82, 84 cannot be removed from the trailer jack and would prevent rotation of the trailer jack crank by binding or otherwise interfering with its rotation. It should be appreciated that the front bar 80, intermediate bar 82, and rear bar 84 may be contoured or shaped as desired or required to adequately engage the trailer jack.

Referring to FIGS. 1-12, the jack lock 10 and any of its associated components may be made from any appropriate material or combination of materials including, but not limited to, metals, plastics, composites, or any other natural or man-made materials. The materials may be selected for their strength, cost, ease of manufacture, resistance to corrosion and exposure to water or other elements, aesthetic appearance, or any other criteria as necessary for a particular application. In certain embodiments, the jack lock 10 or any of its components may be manufactured or otherwise made from materials that are rigid, pliant, or flexible. For example, the jack lock 10 or any of its components may be made from rigid materials such as, though not limited to, steel, aluminum, fiberglass, or other materials that are not intended to flex or deflect during usage. The jack lock 10 may also be made from materials that are pliant such as, but not limited to, elastomers, plastics, rubbers, or other materials which are intended to flex during use. Such pliant materials may be useful for providing impact absorption or preventing damage to the underlying trailer jack from impacts. The jack lock 10 may also be made from flexible materials such as Kevlar or other fabrics that will prevent access or usage of the trailer jack, but are flexible and form-fitting to allow for the jack lock 10 to fit multiple contours, shapes, and sizes of trailer jack. Furthermore, the jack lock 10 or any of its components may be stamped, molded, cast, forged, or otherwise formed into the desired shapes or configurations, and any part described herein may be provided in separate pieces, or multiple parts of the trailer jack lock 10 may be molded, formed, or otherwise manufactured as a single unit or assembly.

In summary, while the present invention has been described with respect to specific embodiments, many modifications, variations, alterations, substitutions, and equivalents will be apparent to those skilled in the art. The present invention is not to be limited in scope by any of the specific embodiments described herein. Indeed, various modifications of the present invention, in addition to those described herein, will be apparent to those of skill in the art from the foregoing description and accompanying drawings. Accordingly, the invention is to be considered as limited only by the spirit and scope of the following claims, including all modifications and equivalents.

It should be appreciated that any element, part, section, subsection, or component described with reference to any specific embodiment above may be incorporated with, integrated into, or otherwise adapted for use with any other embodiment described herein unless specifically noted otherwise or if it should render the embodiment device non-functional. Likewise, any step described with reference to a particular method or process may be integrated, incorporated, or otherwise combined with other methods or processes described herein unless specifically stated otherwise or if it should render the embodiment method nonfunctional. Furthermore, multiple embodiment devices or embodiment methods may be combined, incorporated, or otherwise integrated into one another to construct or develop further embodiments of the invention described herein.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particular interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

We claim:

1. A trailer jack lock comprising:
a body comprising a first aperture and a second aperture and a top edge and a bottom edge;
wherein said first aperture and said second aperture are positioned such that said first aperture is opposed to said second aperture to define a passage through said body of said trailer jack lock.

2. The trailer jack lock of claim 1, further comprising a lock bar having a first end and a second end;
said first end of said lock bar comprising a lock aperture and said second end of said lock bar comprising a lock bar stop;
wherein said first aperture of said body comprises an entry aperture and said second aperture of said body comprises an exit aperture, said lock bar configured to pass through said entry aperture and said exit aperture; and
wherein said lock bar is configured to engage the bottom side of a trailer jack crank and said bottom edge of said body is configured to engage the top side of the trailer jack crank when said lock bar is located within said entry aperture and said exit aperture.

3. The trailer jack lock of claim 2, wherein said first end of said lock bar has a thickness that is less than an opening width of said entry aperture and an opening width of said exit aperture and said second end of said lock bar has a thickness that is greater than said opening width of said entry aperture.

4. The trailer jack lock of claim 2, further comprising a reinforcement on said first end of said lock bar.

5. The trailer jack lock of claim 1, wherein said body of said trailer jack lock defines a crank aperture and a post aperture and wherein said first aperture and said second aperture are configured to accept a lock shank;
said crank aperture positioned opposite of said post aperture and said first aperture and said second aperture positioned between said crank aperture and said post aperture; and
wherein said body is configured such that said post aperture may accept the post of a trailer jack and said crank aperture may accept a crank handle of the trailer jack.

6. The trailer jack lock of claim 1, wherein said body of said trailer jack lock comprises a first half and a second half;
said first half of said body comprising a first post grip, a first crank grip, and said first aperture, said first aperture disposed between said first post grip and said first crank grip;
said second half of said body comprising a second post grip, a second crank grip, and said second aperture, said second aperture disposed between said second post grip and said second crank grip;
wherein said first post grip and said second post grip define a post aperture and said first crank grip and said second crank grip define a crank aperture when said first aperture is placed in communication with said second aperture; and
wherein said first aperture and said second aperture are adapted to accept the shank of a lock, said post aperture is adapted to accept a post of a trailer jack, and said crank aperture is adapted to accept a crank of the trailer jack.

7. The trailer jack lock of claim 1, wherein said body of said trailer jack lock comprises a first half and a second half;
said first half of said body comprising said first aperture and said second half of said body comprising said second aperture;
a hinge in communication with said first half of said body and said second half of said body, wherein said first half of said body and said second half of said body may pivot about said hinge;
a lock bar having a first end and a second end, said first end of said lock bar comprising a lock aperture and said second end of said lock bar comprising a lock bar stop;
wherein said first aperture comprises an entry aperture and said second aperture comprises an exit aperture, said lock bar configured to pass through said entry aperture and said exit aperture; and
wherein said lock bar is configured to engage the bottom side of a trailer jack crank and said bottom edge of said body is configured to engage the top side of the trailer jack crank when said lock bar is located within said entry aperture and said exit aperture.

8. The trailer jack lock of claim 7, wherein said first end of said lock bar has a thickness that is less than an opening width of said entry aperture and an opening width of said exit aperture and said lock bar stop of said lock bar has a thickness that is greater than an opening width of said entry aperture.

9. The trailer jack lock of claim 8, wherein the distance between said lock aperture and said lock bar stop is selected such that said first half of said body and said second half of said body are retained in a closed position when said lock bar is located within said entry aperture and said exit aperture and secured with a lock passing through said lock aperture.

10. The trailer jack lock of claim 7, further comprising a first lock ring in communication with said first half of said body and a second lock ring in communication with said second half of said body;
wherein said first half of said body and said second half of said body are retained in a closed position when a lock passes through said first lock ring and said second lock ring.

11. A trailer jack lock comprising:
a body comprising a first aperture and a second aperture and a top edge and a bottom edge;
a clearance aperture disposed within said body between said first aperture and said second aperture, said clearance aperture extending to said bottom edge of said body; and
wherein said first aperture and said second aperture are positioned such that said first aperture is opposed to said second aperture to define a passage through said body of said trailer jack lock and said clearance aperture is positioned to accept a crank of a trailer jack.

12. The trailer jack lock of claim 11, further comprising a lock bar having a first end and a second end;
said first end of said lock bar comprising a lock aperture and said second end of said lock bar comprising a lock bar stop;
wherein said first aperture of said body comprises an entry aperture and said second aperture of said body comprises an exit aperture, said lock bar configured to pass through said entry aperture and said exit aperture; and
wherein said lock bar is configured to engage the bottom side of a trailer jack crank and said clearance aperture is configured to engage the trailer jack crank when said lock bar is located within said entry aperture and said exit aperture.

13. The trailer jack lock of claim 12, wherein said first end of said lock bar has a thickness that is less than an opening width of said entry aperture and an opening width of said exit aperture and said second end of said lock bar has a thickness that is greater than an opening width of said entry aperture.

14. The trailer jack lock of claim 12, further comprising a collar;
said collar comprising a first part having a first post recess and a second part having a second post recess;
said first post recess defining a first grip surface and said second post recess defining a second grip surface;
wherein said first post recess and said second post recess are configured to engage a pole of a trailer jack through said first grip surface and said second grip surface; and
wherein said collar comprises an outer shape that is non-circular and adapted to engage an inner edge of said body of said trailer jack lock.

15. A trailer jack lock comprising:
a body comprising a first aperture and a second aperture and a top edge and a bottom edge, said first aperture comprising an entry aperture, said second aperture comprising an exit aperture, and said bottom edge defining an opening to accept a trailer jack;
a lock bar having a first end and a second end, said lock bar configured to pass through said entry aperture and said exit aperture;
said first end of said lock bar comprising a lock aperture and said second end of said lock bar comprising a lock bar stop;
wherein said first aperture and said second aperture are positioned such that said first aperture is opposed to said second aperture to define a passage through said body of said trailer jack lock; and
wherein said lock bar is configured to engage a head of the trailer jack to prevent the head of the trailer jack passing vertically through said opening defined by said bottom edge of said body when said lock bar is located within said entry aperture and said exit aperture.

16. The trailer jack lock of claim 15, wherein said first end of said lock bar has a thickness that is less than an opening width of said entry aperture and an opening width of said exit aperture and said second end of said lock bar has a thickness that is greater than said opening width of said entry aperture.

17. The trailer jack lock of claim 15, further comprising:
a lower lock bar stop;
a pole relief;
a lower lock aperture guard; and
an upper lock aperture guard;
wherein said lower lock bar stop is disposed about said second end of said lock bar, said upper lock aperture guard and said lower lock aperture guard disposed about said first end of said lock bar, and wherein said pole relief is positioned to provide clearance between said lock bar and said bottom edge of said body to accept a pole of the trailer jack.

18. The trailer jack lock of claim 15, wherein said body of said trailer jack lock comprises a first half and a second half;
said first half of said body comprising said first aperture and said second half of said body comprising said second aperture;
a hinge in communication with said first half of said body and said second half of said body, wherein said first half of said body and said half of said body may pivot about said hinge;
a lower engagement component configured to engage the lower end of a trailer jack; and
a first lock ring in communication with said first half of said body and a second lock ring in communication with said second half of said body;
wherein said first half of said body and said second half of said body are retained in a closed position when a lock passes through said first lock ring and said second lock ring.

19. The trailer jack lock of claim 18, wherein said lower engagement component comprises a floor incorporating a pole recess adapted to accept a pole of the trailer jack.

20. The trailer jack lock of claim 17, further comprising a locking tab positioned on said body proximate to said exit aperture;
wherein said locking tab is adapted to accept a lock shank to secure said lock bar to said body when the lock shank is passed through said locking tab on said body and said lock aperture on said lock bar.
